(19) United States
(12) Patent Application Publication
(10) Pub. No.: US 2007/0096569 A1
(43) Pub. Date: May 3, 2007

(54) Hollow Pump

(76) Inventor: William Sheridan Fielder, Ojai, CA (US)

Correspondence Address: WILLIAM S. FIELDER, P.O. Box 1221, OJAI, CA, 93024-1221, US

(21) Appl. No.: 11/590,622

(22) Filed: Oct. 30, 2006

Related U.S. Application Data
(60) Provisional application No. 60/731,665, filed on Oct. 31, 2005.

(51) Int. Cl. B63H 21/17; H02K 23/40; H01R 39/08

(52) U.S. Cl. 310/40 R; 440/6; 310/156.01; 310/211; 310/83; 310/162; 310/232; 417/423.1; 417/423.5

(57) ABSTRACT

A versatile, efficient, compact pump featuring an all-in-one rotor/blade design. Utilizing the concepts of a three-phase AC synchronous motor, this invention is capable of the heavy lifting required along California's aqueducts as well as for propelling large vessels. Reduced weight, size and complexity results in energy savings when compared to conventional designs.

### CROSS-REFERENCE TO RELATED APPLICATIONS:

This application claims the benefit of provisional patent application Appl. No. 60/731,665, filed Oct. 31, 2005 by the present inventor.

This application is related to application, application Ser. No. 10/885,876, filed Jul. 6, 2004, by the present inventor. Everything included in this application, application Ser. No. 10/885,876, HOLLOW TURBINE, is incorporated by reference in the present application.

This application is related to application, application Ser. No. 11/410,387, filed Apr. 24, 2006, by the present inventor. Everything included in this application, application Ser. No. 11/410,387, HOLLOW GENERATOR, is incorporated by reference in the present application.

This application is related to application, Provisional Appl. No. 60/845,036, filed Sep. 14, 2006, by the present inventor. Everything included in this provisional application, Appl. No. 60/845,036, HOLLOW HYDROELECTRIC GENERATOR, is incorporated by reference in the present application.

### FEDERALLY SPONSORED RESEARCH: None

### SEQUENCE LISTING: None

### BACKGROUND—FIELD OF INVENTION

This invention generally relates to electric pumps, specifically the pumps used along California's aqueducts and as a propulsion means for vessels.

### BACKGROUND—PRIOR ART

Previously, conventional electric pumps used to lift water over steep elevations, such as the Tehachapi Mountains along the California aqueduct, suffer from the same disadvantages as conventional hydroelectric generators, such as those at Hoover Dam and illustrated in FIG. 1. Foremost among these disadvantages is the separation of the steel turbine and rotor by a massive steel shaft. This design is inefficient and requires too much space.

Ships and boats share a common liability, an exposed propeller and drive shaft that may become entangled or otherwise compromised. This design also limits maneuverability.

### BACKGROUND—OBJECTS AND ADVANTAGES

Accordingly, several objects and advantages of the invention are that it further extends the unique advantages leveraged by the HOLLOW TURBINE and HOLLOW HYDROELECTRIC GENERATOR. Chief among these advantages is the all-in-one turbine and rotor, incorporated here as an all-in-one pump. This reduces complexity, weight, space, and energy requirements. This design eliminates not only the connecting shaft, but also the axle found in conventional rotors and pump blade implementations.

Installing the present invention to replace the existing pumps, along California's aqueduct, together with at least one HOLLOW ELECTRIC GENERATOR to capture the energy now lost when the water descends, will significantly reduce the electricity now required to operate the pump.

Incorporated as a propeller, safely tucked away within a vessel's hull, this pump is capable of propelling a vessel. Installing multiple pumps horizontally, in parallel, will increase maneuverability, especially if the intake pipes open on the sides of the vessel. A telescoping keel will enable these vessels to enter ports previously unapproachable.

### SUMMARY

This is a new use patent, that incorporates a HOLLOW TURBINE, a HOLLOW GENERATOR, and a HOLLOW HYDROELECTRIC GENERATOR; the result is a versatile and efficient pump. Instead of harvesting electrical energy from kinetic energy, this invention utilizes electrical current to turn a HOLLOW GENERATOR's cylinder, effectively creating a pump.

The very large three-phase AC synchronous motors utilized here are capable of tens of thousands of kW in output, and are commonly used for pipeline compressors and wind-tunnel drives. This makes the present invention suitable for the heavy lifting required along California's aqueducts as well as for propelling large vessels.

### DRAWINGS—FIGURES

FIG. 1 PRIOR ART is a side view of a traditional hydroelectric generator.

FIG. 2 is a front view of a HOLLOW TURBINE and its blades.

FIG. 3 is a side view of the preferred embodiment, a three-phase AC synchronous pump with both slip rings on one side of the rotor.

FIG. 4 is a side view of the preferred embodiment, a three-phase AC synchronous pump with a slip ring on both sides of the rotor.

FIG. 5 is a side view of a three-phase AC synchronous pump with permanent magnets mounted on the rotor.

FIG. 6 is a side view of an AC induction pump.

FIG. 7 is a cross-sectional view of a waterproof inclosure for the present invention that incorporates rotational energy connecting elements instead of a all-in-one pump and rotor.

FIG. 8 is an illustration of how the present invention and two hydroelectric generators provide an efficient means of pumping water over an elevation.

FIGS. 9 through 11 depict HOLLOW PUMPs as a means of propelling boats and vessels.

FIG. 12 illustrates a conventional hull with telescoping keel retracted.

FIGS. 13 to 15 is a rear view of a vessel's hull with a telescoping keel in various stages of extension.

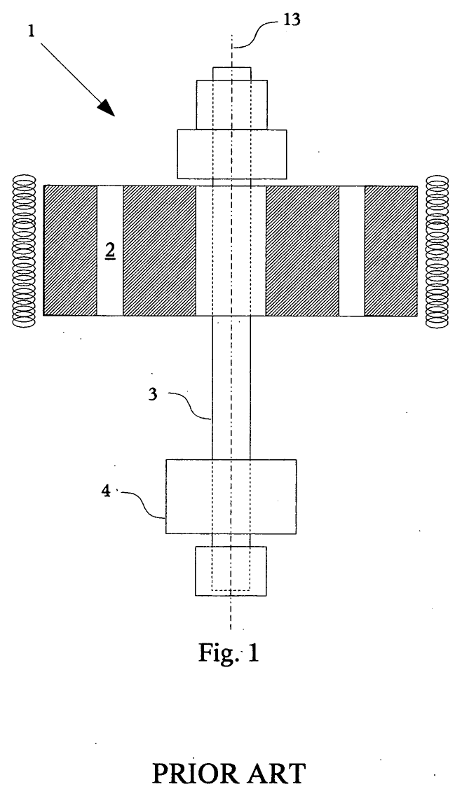

### DRAWINGS—REFERENCE NUMERALS

1 Traditional hydroelectric generator/pump
2 Rotor
3 Shaft
4 Turbine/pump
5 HOLLOW TURBINE blades
6 Inner surface of a HOLLOW TURBINE's cylinder
7 Outer surface of a HOLLOW TURBINE's cylinder
8 Rotor
9 Rotor coils
10 Slip rings
11 Brushes
12 Stator
13 Axis of rotation
14 Permanent magnet
15 Bar conductor capable of carrying an eddy current
16. Bearing
17. Turbine shroud
18 Pipeline
19 Intake
20 Rotational energy connecting element
21 Axil
22 Bearing
23 Electric motor
24 Waterproof housing
25 Direction of flow
26 HOLLOW PUMP
27 HOLLOW HYDROELECTRIC GENERATOR
28 Vessel
29. Telescoping keel

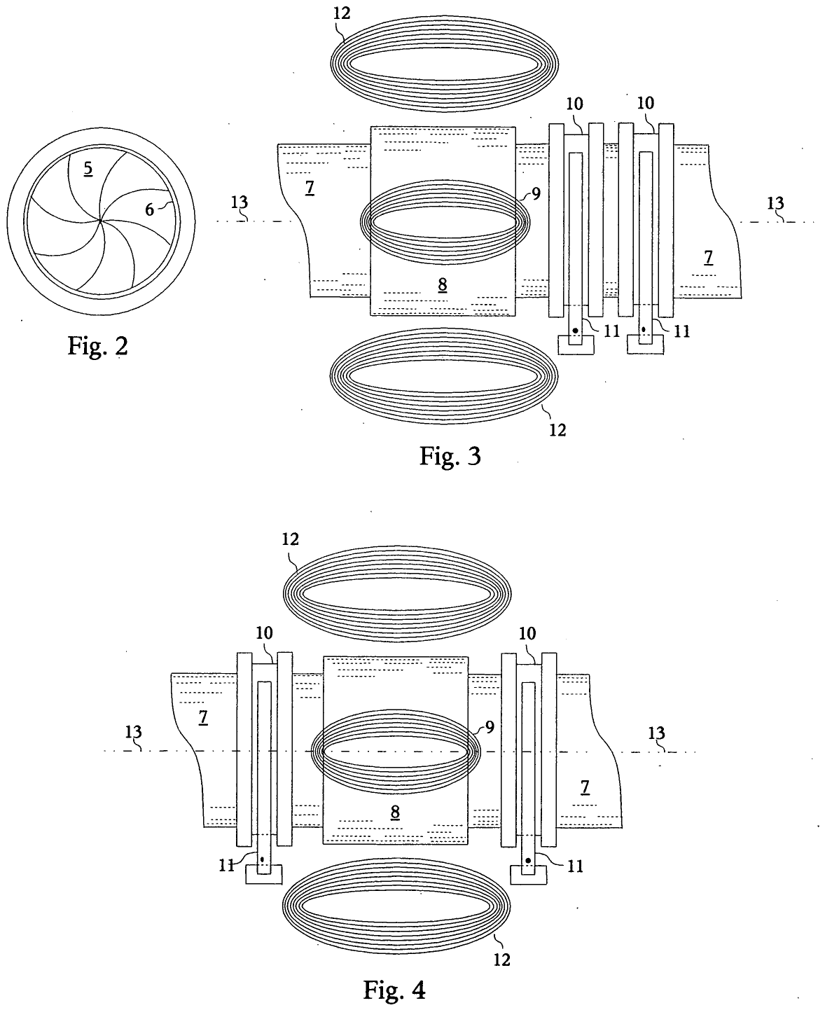

### DETAILED DESCRIPTION—PREFERRED EMBODIMENT—FIGS. 2, 3 AND 4

Three outside stators 12, only two shown, having coils supplied with an alternating current, produce a rotating magnetic field. Inside rotor coils 9 are attached to the outside surface of a cylinder 7 that is free to rotate within the stators 12. The cylinder 6 has an array of blades 5 symmetrically attached to its inner surface 6 and is given torque by the rotating magnetic field.

Rotor coils 9 are connected to electric current via two slip rings 10; each is attached to the cylinder 7 on the same side of the rotor coils 9 as in FIG. 3, or on opposite sides 10 as shown in FIG. 4. The two slip rings 10 make electrical contact with two carbon brushes 11 that connect to a separate field current that creates a continuous magnetic field.

The motor is driven by a transistorized variable frequency drive, not shown, and will rotate in synchronism with the rotating magnetic field produced by the polyphase electrical supply. The result is a three-phase AC synchronous motor whose axil/output shaft is a pump. A one-phase design, using ordinary AC, is also possible for smaller loads.

### Operation—Preferred embodiment—FIGS. 2, 3 and 4

Direct current is supplied to the rotor coils 9 to produce a continuous magnetic field. Alternating current is applied to the stators 12 that produces a rotating magnetic field. Under a wide range of conditions, the rotor 8 and attached cylinder 7 will rotate in synchronism with the rotating magnetic field produced by the polyphase electrical supply. As the rotor 8 and attached blades 5 rotate, they effectively transfer any substances that come into contact with the blades 5 from one end of the cylinder 7 to the other.

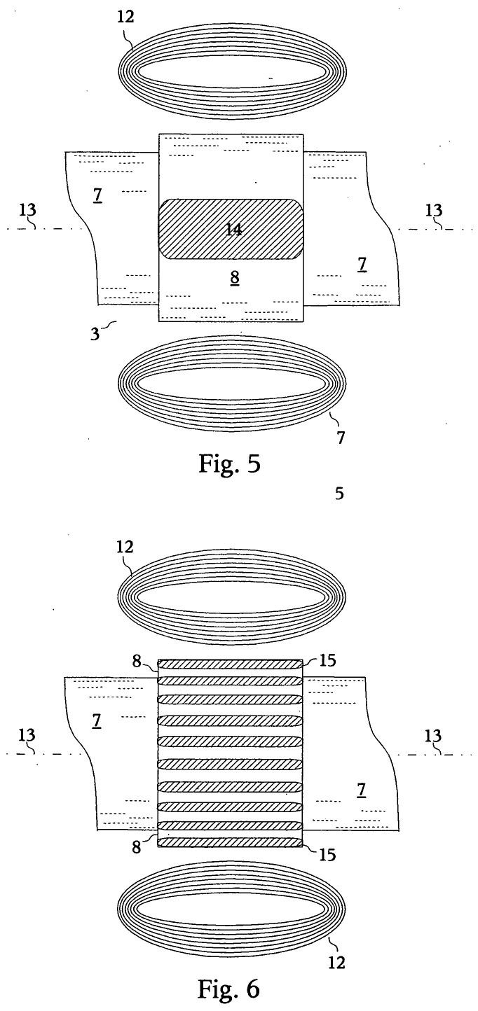

### Detailed Description—FIGS. 2 and 5

Three outside stators 12, only two shown, having coils supplied with an alternating current, produce a rotating magnetic field. Permanent magnets 14 attached to the outside surface of a cylinder 7 are free to rotate within the stators 12. The cylinder 6, FIG. 2, has an array of blades 5 symmetrically attached to its inner surface 6 and is given torque by the rotating magnetic field.

The motor is driven by a transistorized variable frequency drive, not shown, and will rotate in synchronism with the rotating magnetic field produced by the polyphase electrical supply. The result is a three-phase AC synchronous motor whose axil/output shaft is a pump. A one-phase design, using ordinary AC, is also possible for small loads.

### Operation FIGS. 2 and 5

Alternating current is applied to the stators 12 producing a rotating magnetic field. Under a wide range of conditions, the rotor 8 and attached cylinder 7 will rotate in synchronism with the rotating magnetic field produced by the polyphase electrical supply. As the rotor 8 and attached blades 5, FIG. 2, rotate, they effectively transfer any substances that come into contact with the blades 5, FIG. 2, from one end of the cylinder 6, FIG. 2, to the other.

### Detailed Description—FIGS. 2 and 6

Three outside stators 12, only two shown, having coils supplied with an alternating current, produce a rotating magnetic field. A plurality of conductors 15, in the shape of a bar and capable of carrying an eddy current, are attached to the outer surface or embedded into a cylinder 7. Two circular conductors, not shown and typically made form cast aluminum, are joined by the conducting bars 15. Any two bars 15 and the arcs, not shown, that join them form a coil as they pass a magnetic field. The cylinder 6, FIG. 2, has an array of blades 5 symmetrically attached to its inner surface 6 and is given torque by the rotating magnetic field. With single phase AC, one can produce a rotating field by generating two currents that are out of phase using, for example, a capacitor.

### Operation FIGS. 2 and 6

The three wires, not shown, (not counting earth) carry three potential differences which are out of phase with each other by 120°, producing a smoothly rotating field. Current within the stators 12 energizes the coils, not shown, mounted on the rotor 8-that will turn at a rate slightly lower than that of the rotating magnetic field.

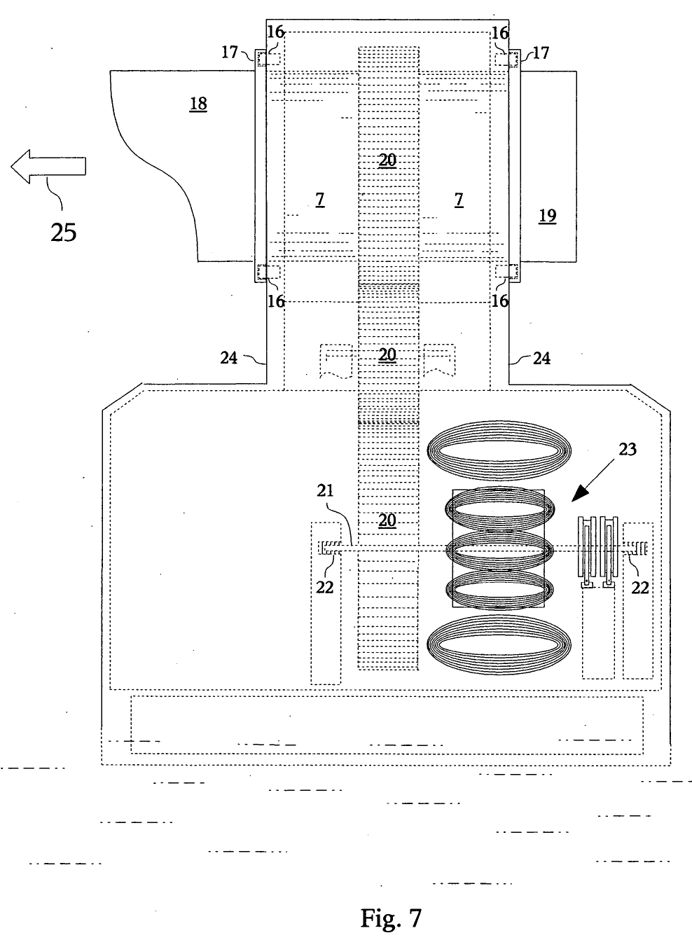

### Detailed Description—FIG. 7

This embodiment of the present invention separates the cylinder 6, FIG. 2, with attached blades 5, from the alternating magnetic fields. Rotational energy connecting elements 20 connect an electric motor 23 with the cylinder 7. Blades 5 symmetrically attached to the inner surface of the cylinder 6, FIG. 2, form the pump. The cylinder 7 rotates on bearings 16 that attach to the waterproof housing 24. An intake pipe 19 and exhaust pipeline 18, attach to the turbine shroud 17.

### Operation FIG. 7

Electric current energizes the motor 23 that rotates the axil 21 on bearings 22. Rotational energy is transferred by rotational energy connecting elements 20 that turn the cylinder 7 and blades 5, FIG. 2, that connect to the intake pipe 19 and the pipeline 18.

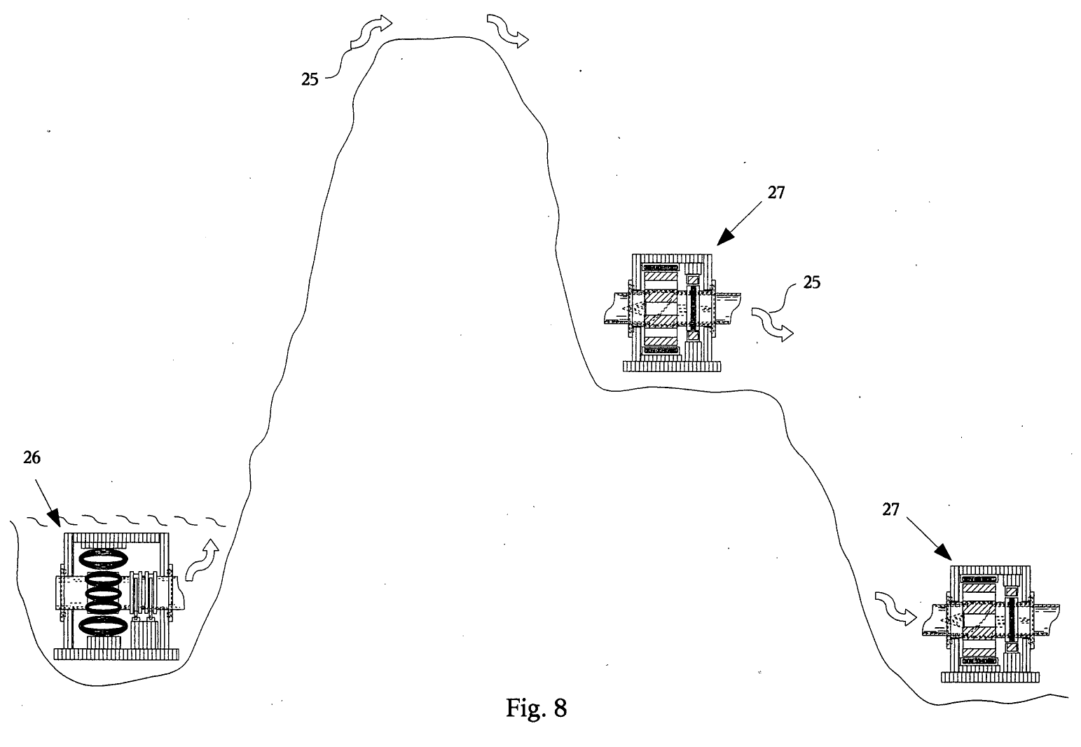

### Detailed Description—FIG. 8

This an illustration of the present invention 26 as utilized in conjunction with HOLLOW HYDROELECTRIC GENERATORs 27 to offset the high energy requirements of pumping water over high elevations. The pump 26, submerged in an aqueduct, is connected to a pipeline, not shown, that carries the water over an elevation 25 to hydroelectric generators 27 on the downward side of said elevation. Transmission lines, not shown, route the electricity generated back to the initial pumps 26.

### Operation FIG. 8

Descending water powers the hydroelectric generators 27 that produce electricity which is transmitted by power lines, not shown, back to the pump 26 forming a complete circuit and reducing the amount of electricity needed from the grid. The discharged water continues along the aqueduct as usual.

### Detailed Description—FIGS. 9, 10, and 11

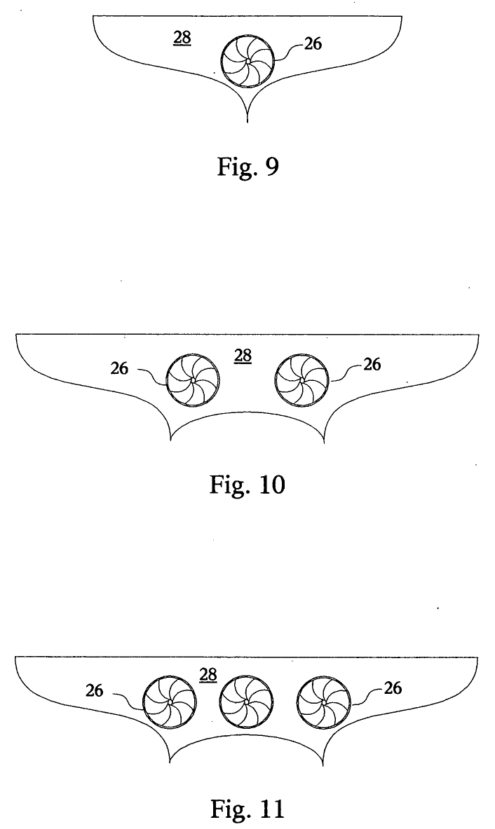

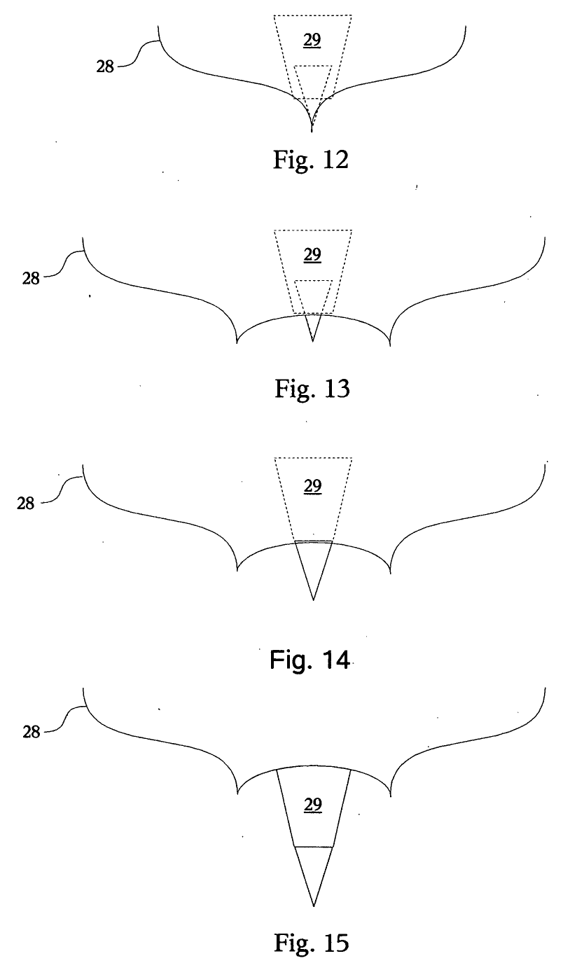

This embodiment utilizes the present invention 26 to propel boats and ships 28. The cylinder, not shown, is incorporated into the hull with intakes at the front, along the sides of, or at the bottom of the vessel, also not shown. One intake may supply multiple in-line pumps 26, to increase power. Multiple parallel pumps 26, FIGS. 10 and 11, will improve maneuverability by reducing or reversing the flow in one of the pumps 26. A telescoping keel 29, FIGS. 12-15, made from stainless steel or other suitable material, can be deployed and retracted by hydraulics or an actuator, not shown, for shallow harbors.

This design may also be suitable for submarines and high performance boats. A directional nozzle or rudder will enable steering, and a hydrofoil will increase efficiency, as well as keep the bow submerged. Steering may also be achieved by applying different amounts of rotational or electric energy to the pumps on opposing sides of the ship. Removal of the propeller shaft eliminates a point of failure in the power train.

### Operation—FIGS. 9, 10, and 11

The pumps 26 are energized by either electricity or a rotational energy source, as outlined in the previous descriptions of the present invention. Water enters the pump, or multiple pumps, from intakes along the sides, the bottom or bow of the ship 28, and exits at the stern, causing forward motion. If intake pipes are incorporated along the two sides of the ship, reducing or reversing the flow on one side will cause the vessel to turn in that direction.

### CONCLUSION, RAMIFICATIONS, AND SCOPE

Accordingly, the reader will see that according to the invention, I have provided a new means of saving energy along California's aqueduct system, as well as a new means of propelling vessels.

While the above description contains many specificitiess, these should not be construed as limitations on the scope of the invention, but as exemplifications of the presently preferred embodiments thereof. Other ramifications and variations are possible within the teachings of the invention. For example, reservoirs and grain elevators may also benefit.

Thus the scope of the invention should be determined by the appended claims and their legal equivalents, and not by the examples given.

I claim:

1. A pump comprising:
a hollow cylinder having an array of blades symmetrically attached to the inner surface of said hollow cylinder and further comprising a means of rotation wherein said means are bearings;
a source of rotational energy to rotate said hollow cylinder with attached blades;
whereby providing an effective and efficient pump.

2. The source of rotational energy as claimed in claim #1, wherein the said source of rotational energy is an AC motor comprising:
at least two stators;
at least two rotor coils.

3. The AC motor as claimed in claim #2, wherein the axil of said motor is a said hollow cylinder further comprising an array of blades symmetrically attached within said cylinder;
whereby an all-in-one motor/pump is achieved.

4. The source of rotational energy as claimed in claim #1, wherein the said source of rotational energy is a three-phase AC synchronous motor comprising:
at least three stators;
at least two rotor coils.

5. The three-phase AC synchronous motor as claimed in claim #4, wherein the axil of said motor is a said hollow cylinder further comprising an array of blades symmetrically attached within said cylinder;
whereby an all-in-one motor/pump is achieved.

6. The source of rotational energy as claimed in claim #1, wherein the said source of rotational energy is a three-phase AC synchronous motor comprising:
at least three stators;
at least one permanent magnet.

7. The three-phase AC synchronous motor as claimed in claim #6, wherein the axil of said motor is a said hollow cylinder further comprising an array of blades symmetrically attached within said cylinder;
whereby an all-in-one motor/pump is achieved.

8. The source of rotational energy as claimed in claim #1, wherein the said source of rotational energy is a three-phase AC induction motor comprising:
at least two conducting bars capable of carrying an eddy current;
at least two electricity conducting rings attached to the opposite ends of said at least two conducting bars;
at least three stators.

9. The three-phase AC induction motor, as claimed in claim 8, wherein the axil of said motor is a said hollow cylinder further comprising an array of blades symmetrically attached within said cylinder;
whereby an all-in-one motor/pump is achieved.

10. The source of rotational energy as claimed in claim #1,wherein the said source of rotational energy is an AC induction motor comprising:
at least two conducting bars capable of carrying an eddy current;
at least two electricity conducting rings attached to the opposite ends of said at least two conducting bars;
at least two stators.

11. The AC induction motor, as claimed in claim #10, wherein the axil of said motor is a said hollow cylinder further comprising an array of blades symmetrically attached within said cylinder;
whereby an all-in-one motor/pump is achieved.

12. The source of rotational energy as claimed in claim #1, wherein the said source of rotational energy is an DC motor.

13. The DC motor, as claimed in claim #12, wherein the axil of said motor is a said hollow cylinder further comprising an array of blades symmetrically attached within said cylinder;
whereby an all-in-one motor/pump is achieved.

14. The source of rotational energy as claimed in claim #1,wherein the said source of rotational energy is a rotational energy connecting element and further comprising an electric motor;
whereby providing a constant source of rotational energy.

15. Method and apparatus for pumping water over elevations and generating electricity comprising:
providing at least one pump;
providing at least one hydroelectric generator;
providing at least one connecting water pipeline connecting said pump to said hydroelectric generator;
providing at least one electrical transmission means connecting said hydroelectric generator to said pump;
whereby a substantial amount of the energy needed to pump water over an elevation is captured and returned to the pump.

16. The at least one pump as claimed in claim #15, wherein the axil of the said pump is a hollow cylinder and further comprising an array of blades symmetrically attached to the inside of said hollow cylinder.

17. The at least one hydroelectric generator as claimed in claim #15, wherein the said hydroelectric generator is a referenced HOLLOW HYDROELECTRIC GENERATOR.

18. The at least one electrical transmission means, as claimed in claim #15, wherein the said transmission means is the electric power grid.

19. The at least one electrical transmission means, as claimed in claim #15, wherein the said transmission means are electric transmission lines connected directly from said at least one generator to said at least one pump.

20. Method and apparatus for propelling vessels through water comprising:
providing at least one hollow cylinder having an array of blades symmetrically attached to the inner surface of said hollow cylinder and firther comprising a means of rotation wherein said means are bearings;
providing at least one intake pipe;
providing at least one exhaust pipe;
providing a source of rotational energy to rotate the said at least one hollow cylinder with attached blades.

21. The vessel as claimed in claim #20, further comprising a telescoping keel;
whereby large vessels are safe at sea and also capable of navigating shallow harbors.
